(19) United States
(12) Patent Application Publication
(10) Pub. No.: US 2013/0058093 A1
(43) Pub. Date: Mar. 7, 2013

(54) SELF-BALLASTED REFLECTORIZED INTEGRATED FLAT PANEL LAMP

(71) Applicants: Noel Park, San Jose, CA (US); Fu-Min Guan, Shanghai (CN); Steve Johnson, Newburyport, MA (US)

(72) Inventors: Noel Park, San Jose, CA (US); Fu-Min Guan, Shanghai (CN); Steve Johnson, Newburyport, MA (US)

(73) Assignees: MATH BRIGHT TECHNOLOGY CO., LTD., Taoyuan (TW); LUMIETTE INC., San Jose, CA (US)

(21) Appl. No.: 13/697,325

(22) PCT Filed: May 9, 2011
(86) PCT No.: PCT/US11/35787

§ 371 Date: Nov. 9, 2012

Related U.S. Application Data
(60) Provisional application No. 61/333,630, filed on May 11, 2010.

(51) Int. Cl. F21V 7/05

(52) U.S. Cl. 362/260

(57) ABSTRACT

Embodiments of the present invention generally relate to an integrated compact fluorescent reflector flat panel lamp. In one aspect, an integrated compact fluorescent reflector flat panel lamp is provided. The integrated compact fluorescent reflector flat panel lamp includes a housing, a flat panel lamp portion disposed in the upper part of the housing, lamp circuitry/ballast disposed in the lower part of the housing and a screw type base.

### CROSS-REFERENCE TO RELATED APPLICATIONS

This application claims the benefit of United States provisional patent application Ser. No. 61/333,630, filed May 11, 2010, which is herein incorporated by reference.

### BACKGROUND OF THE INVENTION

1. Field of the Invention

Embodiments of the present invention generally relate to a flat panel lamp. More particularly, the present invention is a compact fluorescent reflectorized flat panel lamp.

2. Description of the Related Art

A conventional integrated compact fluorescent reflector lamp is a type of fluorescent lamp with a ballast integrated into the lamp housing. The conventional compact fluorescent reflector lamp is designed to fit into existing light fixtures formerly used for incandescent lamps. FIG. 1 is a view that illustrates a conventional integrated compact fluorescent reflector lamp 10. The conventional integrated compact fluorescent reflector lamp 10 includes a screw base 15 that is configured to fit into the light fixture. The conventional integrated compact fluorescent reflector lamp 10 further includes a circuit board/ballast 25. The ballast 25 is configured to control the current flowing through the tube 40 and to heat the cathodes 35. The conventional integrated compact fluorescent reflector lamp 10 also includes tube 40 having ends attached to the cathodes 35. The tube 40 contains a fill gas, mercury, and is coated with phosphor and protective coatings. The conventional integrated compact fluorescent reflector lamp 10 also includes a reflector portion 50 that functions to re-direct the light emitted from the tube 40 out the front of the conventional integrated compact fluorescent reflector lamp 10.

The conventional integrated compact fluorescent reflector lamp 10 functions identically to a standard fluorescent lamp. When the conventional integrated compact fluorescent reflector lamp 10 is turned on, current flows through the circuit-board/ballast to the cathodes 35, which causes electrons to migrate through the gas from one end of the tube 40 to the other. The energy created by the electrons changes some of the mercury in the tube 40 from atoms to ions. As more electrons and charged atoms move through the tube 40, the electrons and charged atoms collide with the gaseous mercury atoms. The gaseous mercury atoms are excited due to the collisions and cause electrons in the mercury atoms to bump up to a higher energy levels. Then, as the electrons return to their original energy level, they release light photons which react with the phosphor in the tube 40 to emit light that is in the visible spectrum.

There are several drawbacks to conventional integrated compact fluorescent reflector lamps 10. One drawback is that the light emitted from the tube 40 is emitted in all directions and relies on the reflector 50 to redirect the light 65 out through the front of the conventional integrated compact fluorescent reflector lamp 10. As such, the useful light 65 is limited to a portion of the actual light emitted from tube 40 (see FIG. 2). Another drawback is that switch cycle life (turn on and turn off) of internal cathodes 35 is limited, thus causing the conventional integrated compact fluorescent reflector lamp 10 to prematurely fail as a result of frequently turning on and off the lamp. A need therefore exists for a lamp that overcomes these drawbacks.

### SUMMARY OF THE INVENTION

Embodiments of the present invention generally relate to a fluorescent flat panel lamp, in particular an integrated compact fluorescent reflector flat panel lamp. The integrated compact fluorescent reflector flat panel lamp includes a housing having an upper portion and a lower portion. The integrated compact fluorescent reflector flat panel lamp further includes a fluorescent flat panel lamp, having a substantially flat light emission plane, disposed in the upper portion of the housing.

In another embodiment, an integrated flat panel lamp is provided. The integrated flat panel lamp includes a housing having a first portion and a second portion. The integrated flat panel lamp further includes a fluorescent flat panel lamp, having a substantially flat light emission plane, disposed within the first portion of the housing. Additionally, the fluorescent flat panel lamp includes a base attached to the second portion of the housing, wherein the base is configured to be attachable to a receptacle.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however that the appended drawings illustrate only typical embodiments of this invention and are therefore not to be considered limiting of its scope, for the invention may admit to other equally effective embodiments.

FIG. 1 is a view illustrating a conventional integrated compact fluorescent reflector lamp.

FIG. 2 is a view illustrating the useful light emitted from the conventional integrated compact fluorescent reflector lamp.

FIG. 3 is a view illustrating an embodiment of an integrated compact fluorescent reflector flat panel lamp.

FIG. 4 is a view illustrating the useful light emitted from the integrated compact fluorescent reflector flat panel lamp.

### DETAILED DESCRIPTION

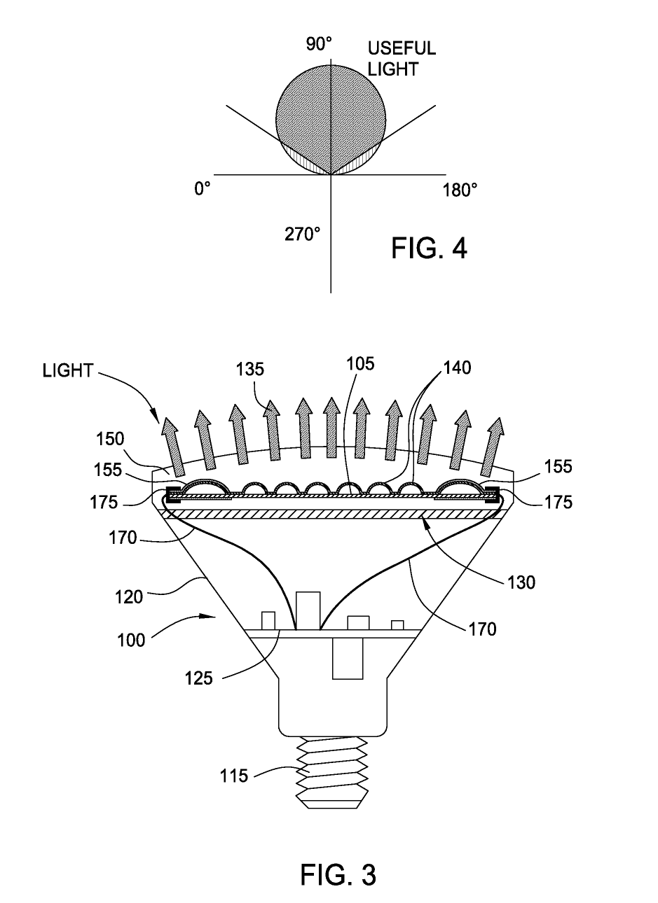

FIG. 3 is a view illustrating an integrated compact fluorescent reflector flat panel lamp 100 according to one embodiment of the invention. The integrated compact fluorescent reflector flat panel lamp 100 has dimensions similar to conventional integrated compact fluorescent reflector lamps, e.g., PAR-30, PAR-38, PAR-40. As will be described herein, the integrated compact fluorescent reflector flat panel lamp 100 has several distinct advantages over the conventional integrated compact fluorescent reflector lamp 10. Specifically, the integrated compact fluorescent reflector flat panel lamp 100 has a longer life than the conventional integrated compact fluorescent reflector lamp 10. Further, the integrated compact fluorescent reflector flat panel lamp 100 emits all of its useful light 135 as compared to the conventional integrated compact fluorescent reflector lamp 10, as will be described herein.

As shown in FIG. 3, the integrated compact fluorescent reflector flat panel lamp 100 includes a housing 120, a fluorescent flat panel lamp 150 and lamp circuitry/ballast 125. The fluorescent flat panel lamp 150 is mounted in an upper part of the housing 120, and the ballast 125 is disposed in a lower part of the housing 120. The space between the fluorescent flat panel lamp 150 and the ballast 125 acts as a thermal insulation and can further be enhanced by using suitable insulating materials 130. In one embodiment, the insulation material is a disk that is attached in the housing 120 by a connection material, such as glue. The connection material positions the disk in place within the housing 120 while filling the gaps around the outer edge of the disk. The disk can be made from any type of material, such as a circuit board material, a composite, plastic, etc. The integrated compact fluorescent reflector flat panel lamp 100 is shown configured with a screw in type base 115 for attaching to an appropriate receptacle. It should be noted that the base 115 may be configured with any other base type or style, such as bayonet, bi-pin, and other base configurations known in the art.

The fluorescent flat panel lamp 150 includes a pair of external electrodes 155 that are connected via a channel 140. The channel 140 is defined between a substantially flat glass plate and a formed glass plate. The glass plates are hermetically sealed together. The inner surface of glass plates that define the channel 140 is coated with phosphor and a protective coating. The channel 140 also contains gas and mercury. Further, the channel 140 may have a serpentine shape which is used to increase the length of the channel 140 and results in a larger emitting light portion of the fluorescent flat panel lamp 150.

The integrated compact fluorescent reflector flat panel lamp 100 has a longer life than the conventional integrated compact fluorescent reflector lamp 10.

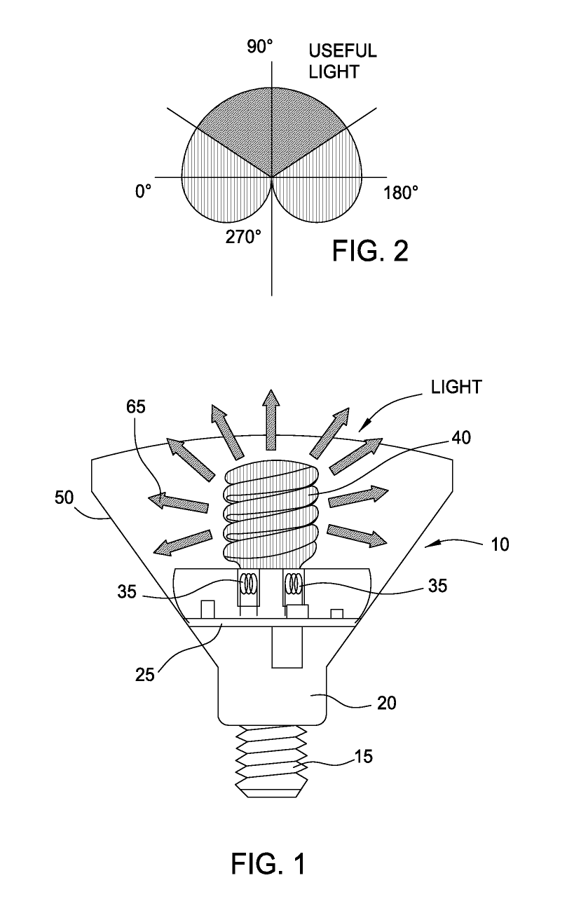

One reason is that the integrated compact fluorescent reflector flat panel lamp 100 has external electrodes 155 which allow for millions of on/off cycles and no contamination of the tube 140 from deterioration of internal filaments. In the conventional integrated compact fluorescent reflector lamp 10, the deterioration of filaments 35 contaminates the tube 40 (FIG. 1) which results in premature failure.

In this manner, the external electrodes 155 and no contamination of the tube 140 allows the integrated compact fluorescent reflector flat panel lamp 100 to have a longer life in comparison to the conventional integrated compact fluorescent reflector lamp 10.

Each external electrode 155 is formed at an end portion of the channel 140. The external electrode 155 has an enlarged cross-section relative to other portions of the channel 140. The external electrodes 155 may include an external electrode coating that is a conductive material. As shown in FIG. 3, a clip 175 is attached to each external electrode 155. The clip 175 electrically connects the top and bottom electrode together. A wire 170 runs from the clip 175 to the lamp circuitry/ballast 125. During operation, AC power is applied through the wire 140 to the clip 175, and an arc current flows through the channel 140.

The electrodes 155 are capacitively coupled. In this respect, each electrode 155 is similar to a capacitor plate that is connected by dielectric in the form of the glass channel 140 and the discharge. An oscillating voltage is applied to the external electrodes 155, which causes electrons to migrate through the gas from one end of the channel 140 to the other. The energy created by the electrons changes some of the mercury in the channel 140 from liquid to gas and ionizes insert gas atoms. As more electrons and charged inert gas atoms move through the channel 140, the electrons and charged inert gas atoms collide with the gaseous mercury atoms. The mercury atoms are excited due to the collision, which causes electrons in the mercury atoms to bump up to higher energy levels. As the electrons return to their original energy level, the electrons release light photons. When the photon hits a phosphor atom in the phosphor coating of the channel 140, one of the phosphor's electrons jumps to a higher energy level, which causes the atom to heat up. When the phosphor electron falls back to its normal level, it releases energy in the form of another photon which gives off light that is in the visible spectrum.

In FIG. 3, light 135 as indicated by the arrows is emitted from a substantially flat light emission plane 105 of the fluorescent flat panel lamp 150. The integrated compact fluorescent reflector flat panel lamp 100 includes an internal reflective coating that provides directionality of the emitted light 135. The internal reflective coating of the integrated compact fluorescent reflector flat panel lamp 100 enhances the emission of light from the light emission plane 105. As such, substantially all the light 135 generated by the integrated compact fluorescent reflector flat panel lamp 100 is useful light as shown in FIG. 4.

In comparing FIG. 4 for the integrated compact fluorescent reflector flat panel lamp 100 to FIG. 2 for the integrated compact fluorescent reflector lamp 10, it can be clearly seen that substantially all the light 135 generated by the integrated compact fluorescent reflector flat panel lamp 100 is useful light, while only a portion of the light 65 generated by the integrated compact fluorescent reflector flat panel lamp 10 is useful light.

While the foregoing is directed to embodiments of the present invention, other and further embodiments of the invention may be devised without departing from the basic scope thereof, and the scope thereof is determined by the claims that follow.

1. An integrated compact fluorescent reflector flat panel lamp comprising:
a housing having an upper portion and a lower portion; and
a fluorescent flat panel lamp disposed within the upper portion of the housing, the fluorescent flat panel lamp having a substantially flat light emission plane.

2. The lamp of claim 1, wherein the fluorescent flat panel lamp includes glass plates that define a channel having external electrodes at each end of the channel.

3. The lamp of claim 2, wherein the channel in the fluorescent flat panel lamp contains gas and mercury.

4. The lamp of claim 2, further comprising a circuit board having a ballast, wherein the circuit board is disposed within a lower portion of the housing and separated from the fluorescent flat panel lamp by a space.

5. The lamp of claim 4, wherein the ballast on the circuit board and the electrodes in the fluorescent flat panel lamp are connected by a wire and clip arrangement.

6. The lamp of claim 5, wherein the circuit board is configured to supply power to the electrodes through the wire and clip arrangement.

7. The lamp of claim 4, further comprising insulation material disposed within the space between the circuit board and the fluorescent flat panel lamp.

8. The lamp of claim 7, wherein the insulation material is a disk member that is attached to the housing by glue.

9. The lamp of claim 1, wherein the fluorescent flat panel lamp includes a reflective coating to direct the light emitted from the substantially flat light emission plane.

10. The lamp of claim 1, further comprising a base attached to the lower portion of the housing, wherein the base is configured to be attachable to a receptacle.

11. The lamp of claim 10, wherein the base is a bayonet base, a bi-pin base or a screw type base.

12. An integrated flat panel lamp comprising:
a housing having a first portion and a second portion;
a fluorescent flat panel lamp disposed within the first portion of the housing, the fluorescent flat panel lamp having a substantially flat light emission plane; and
a base attached to the second portion of the housing, wherein the base is configured to be attachable to a receptacle.

13. The lamp of claim 12, further comprising a circuit board disposed within the second portion of the housing, wherein the circuit board is separated from the fluorescent flat panel lamp by a space.

14. The lamp of claim 13, wherein the fluorescent flat panel lamp includes glass plates that form a channel having external electrodes at each end of the channel.

15. The lamp of claim 14, wherein a ballast on the circuit board and the electrodes in the fluorescent flat panel lamp are connected by a wire.

16. The lamp of claim 13, further comprising insulation material disposed within the space between the circuit board and the fluorescent flat panel lamp.

17. The lamp of claim 16, wherein the insulation material is a disk member that is attached to the housing.

18. The lamp of claim 12, wherein the base is a bayonet base, a bi-pin base or a screw type base.
